(19) United States
(12) Patent Application Publication
(10) Pub. No.: US 2008/0299903 A1
(43) Pub. Date: Dec. 4, 2008

(54) TERMINAL EXCHANGING METHOD AND TERMINAL EXCHANGING APPARATUS USING THE METHOD

(75) Inventors: Hideo Hirono, Narashino-shi (JP); Kazuaki Okamota, Matsudo-shi (JP); Kenji Oi, Tokyo (JP); Yuki Hirata, Kasukabe-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD., Osaka (JP)

(21) Appl. No.: 12/196,562

(22) Filed: Aug. 22, 2008

Related U.S. Application Data
(63) Continuation of application No. PCT/JP2007/000285, filed on Mar. 23, 2007.

(30) Foreign Application Priority Data
Mar. 28, 2006 (JP) 2006-087732

(51) Int. Cl. H04B 7/00

(52) U.S. Cl. 455/39

(57) ABSTRACT

Among a plurality of radio terminal apparatuses, an FMC control apparatus interchanges telephone a telephone number allocated to a first radio terminal apparatus, whose battery is being recharged, with that allocated to a third radio terminal apparatus. Although a radio terminal apparatus is being recharged, a user can perform communication such as telephone calls in the same environments as those of the first radio terminal apparatus whose battery is being recharged by operating on the third radio terminal apparatus using the telephone number allocated to the first radio terminal apparatus whose battery is being recharged.

This is a continuation of International Application No. PCT/JP2007/000285, filed Mar. 23, 2007.

### BACKGROUND OF THE INVENTION

1. Field of the Invention

The present invention relates to a communications technology and it particularly relates to a terminal exchanging method for controlling a plurality of terminal apparatuses and a terminal exchanging apparatus using the method.

2. Description of the Related Art

In recent years, various kinds of communication schemes have been developed owing to the relaxation of regulations in communications. When a user owns a plurality of terminal apparatuses, he/she needs to use a terminal which can be used for various communication schemes. A terminal apparatus generally has a function capable for user to register data, such as telephone numbers or electronic mail addresses. However, if he/she owns a plurality of terminal apparatuses, it was hard, to register the data in all of the terminal apparatuses in proportion to the amount of data. In order to cope with such a problem, there are some conventional techniques which transfer such data by communications.

### SUMMARY OF THE INVENTION

Where the user owns a plurality of terminal apparatuses, a telephone number allocated to each terminal apparatus generally differs from one another. Thus, the user needs to carry with him/her a plurality of radio communication terminals. Also, data, such as telephone numbers to call and electronic mail addresses, stored in a terminal apparatus are often classified as personal data, so that it gets harder to manage the security of such information in proportion to the number of terminal apparatuses.

The present invention has been made in view of the foregoing circumstances described as above, and a general purpose thereof is to provide a terminal exchanging method for controlling a plurality of terminal apparatuses and a terminal exchanging apparatus using the method.

In order to resolve the above problems to be solved, a terminal exchanging apparatus according to one embodiment of the present invention comprises: a terminal detector which detects a first radio terminal apparatus and a second radio terminal apparatus, respectively, wherein a first identification information for identifying a radio terminal apparatus and predetermined data are stored in the first radio terminal apparatus and a second identification information differing from the first identification information is stored in the second radio terminal apparatus; and a data control unit which makes the predetermined data stored in the second radio communication apparatus while making the first identification information stored in the second radio terminal apparatus, when both the first radio terminal apparatus and the second radio terminal apparatus are detected by the terminal detector.

Here, the “identification information” includes a telephone number allocated to each of radio terminal apparatuses. According to this embodiment, predetermined data are stored by the second radio communication apparatus while the identification information of the first radio terminal apparatus is stored in the second radio terminal apparatus. Thereby, the same telephone number can be interchanged among a plurality of radio communication apparatuses and therefore the user usability can be improved. It is to be noted that the identification information of the second radio terminal apparatus may be stored in the first radio terminal apparatus.

The first radio terminal apparatus and the second radio terminal apparatus may each perform a radio communication which differs from that associated with the identification information thereof, and the terminal detector may detect the second terminal apparatus via the first radio terminal apparatus by performing the different radio communication.

Here, the “radio communication associated with the identification information” includes a radio communication associated with a telephone number and a line and it includes, for example, a wireless LAN associated with an IP address. The “different radio communication” includes a short-distance radio communication line and it includes, for example, a radio communication using infrared rays. When another communication of the first radio terminal apparatus is used to detect the second radio terminal apparatus as in this embodiment, an apparatus for detecting the second radio terminal apparatus is no longer needed. Hence, the cost for a system can be reduced.

When the identification information of the second radio terminal apparatus is restored to an original state after the identification information of the first radio terminal apparatus has been stored in the second radio terminal apparatus, the data control unit may delete the predetermined data stored in the second radio terminal apparatus.

Here, a case “when the identification information of the second radio terminal apparatus is restored to an original state” includes deleting the identification information on the first radio terminal apparatus stored in the second radio terminal apparatus and storing again the identification information for the second radio terminal apparatus stored in the past as the identification information of the second radio terminal apparatus. According to this embodiment, when the identification information of the second radio terminal apparatus is restored to the original state after the identification of the first radio terminal apparatus has been stored in the second radio terminal apparatus, the predetermined data stored in the second radio terminal apparatus is deleted. This can enforce the management of information security.

Another embodiment of the present invention relates also to a terminal exchanging apparatus. This apparatus comprises: a terminal detector which detects a first radio terminal apparatus and detects a second radio terminal apparatus via an independent network wherein the first radio terminal stores predetermined data and a radio communication function for public usage is set enabled in the first radio terminal and wherein the second radio terminal apparatus has the radio communication function for public usage and an independent network radio communication function and the radio communication function for public usage is set disabled in the second radio terminal apparatus; and a data control unit which causes the second radio terminal apparatus to store the predetermined data in a manner that the radio communication function for public usage in the first radio terminal apparatus is set disabled and the radio communication function for public usage in the second radio terminal apparatus is set enabled, when both the first radio terminal apparatus an the second radio terminal apparatus are detected by the terminal detector.

Here, the “radio communication function for public usage” includes a mobile radio communication function which can be connected to a public network and it includes, for example, a CDMA (Code Division Multiple Access) mobile radio communication function. The “independent network radio communication function” includes a radio communication function which can be connected to a public network via an independent network and it includes, for example, a wireless LAN (Local Area Network) communication function. According to this embodiment, the predetermined data are stored by the second radio communication apparatus in a manner that the radio communication function for public usage in the first radio terminal apparatus is set disabled and the radio communication function for public usage in the second radio terminal apparatus is set enabled. Thereby, only any one of radio communication apparatuses is capable of performing communication and therefore the management of information security can be enforced.

When the radio communication function for public usage in the first radio terminal apparatus is restored to an enabled state after the radio communication function for public usage in the first radio terminal apparatus has been set disabled, the data control unit may delete the predetermined data by setting disabled the radio communication function for public usage in the second radio terminal apparatus.

According to this embodiment, the predetermined data are deleted from the second radio communication apparatus in a manner that the radio communication function for public usage in the second radio terminal apparatus is set disabled. As a result, the management of information security can be further enforced.

Still another embodiment of the present invention relates to a terminal exchanging method. This method is such that when a first radio terminal apparatus in which identification information for identifying a radio terminal apparatus and predetermined data are stored and a second radio terminal apparatus in which identification information differing from the identification information is stored are detected, the predetermined data are stored in the second radio communication apparatus by storing the identification of the first radio terminal apparatus in the second radio terminal apparatus.

Still another embodiment of the present invention relates to a terminal exchanging method. This method is such that when a first radio terminal apparatus, having at least a radio communication function for public usage, in which the radio communication function for public usage is set enabled is detected and a second radio terminal apparatus, having the radio communication function for public usage and an independent network radio communication function, in which the radio communication function for public usage is set disabled is detected via an independent network, the predetermined data are stored in the second radio communication in a manner that the radio communication function for public usage in the first radio terminal apparatus is set disabled and the radio communication function for public usage in the second radio terminal apparatus is set enabled.

Optional combinations of the aforementioned constituting elements, and implementations of the invention in the form of methods, apparatuses, systems, recording mediums, computer programs and so forth may also be effective as additional modes of the present invention.

According to the present invention, a terminal exchanging method for controlling a plurality of terminals and a terminal exchanging apparatus using the method can be realized.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIGS. 1A and 1B are diagrams showing an FMC communication system according to a first exemplary embodiment and a second exemplary embodiment of the present invention.

FIG. 2 is a diagram showing an exemplary structure of a communication system within a third communication area of FIG. 1.

FIG. 3 is a diagram showing an exemplary structure of an FMC control apparatus shown in FIG. 2.

FIG. 4 is a diagram showing an exemplary structure of a radio terminal apparatus shown in FIG. 2.

FIG. 5 is a sequence diagram showing an operational example of a communication system in a third communication area shown in FIG. 1.

FIG. 6 is a sequence diagram showing an operational example of a communication system according to a modification of an embodiment of the present invention.

### DETAILED DESCRIPTION OF THE INVENTION

The terms and description used in defining the preferred embodiments of the present invention to be taken with the accompanying drawings are set forth for the purposes of clarification and illustration only. The present invention described herein are not meant as limitations but are to be understood to include all the equivalent technologies that are implemented for the similar purpose under the similar rules.

Before explaining an embodiment of the present invention in concrete terms, a brief description will be given first. A communication system according to the embodiment of the present invention is an FMC (Fixed/Mobile Convergence) communication system, and includes an FMC server and a plurality of radio terminal apparatuses. The FMC server performs wireless LAN communications with a plurality of radio terminal apparatuses and manages data stored in their respective radio terminal apparatuses.

Of a plurality of radio terminal apparatuses, the FMC server interchanges a telephone number allocated to a radio terminal apparatus whose battery is being recharged and that allocated to another radio communication terminal. Also, the FMC server stores user data (predetermined data), stored in the radio terminal apparatus whose battery is being recharged, in the another radio terminal apparatus. Thereby, although the battery of the radio terminal apparatus is being recharged, a user can perform communication such as normal telephone calls in the same environments as those of the radio terminal apparatus whose battery is being recharged by operating on the another radio terminal using the telephone number allocated to the radio terminal apparatus whose battery is being recharged. In this manner, a plurality of radio terminal apparatuses are interchanged respectively in cooperation with the FMC terminal system, so that user convenience can be improved. The detail will be discussed later.

A description is now given of “FMC communication system”. The FMC communication system is a communication system resulting from the convergence of communications by wired (fixed) lines via a server fixedly placed at home and the like and mobile communications capable of performing communications even while on the move outdoors and the like.

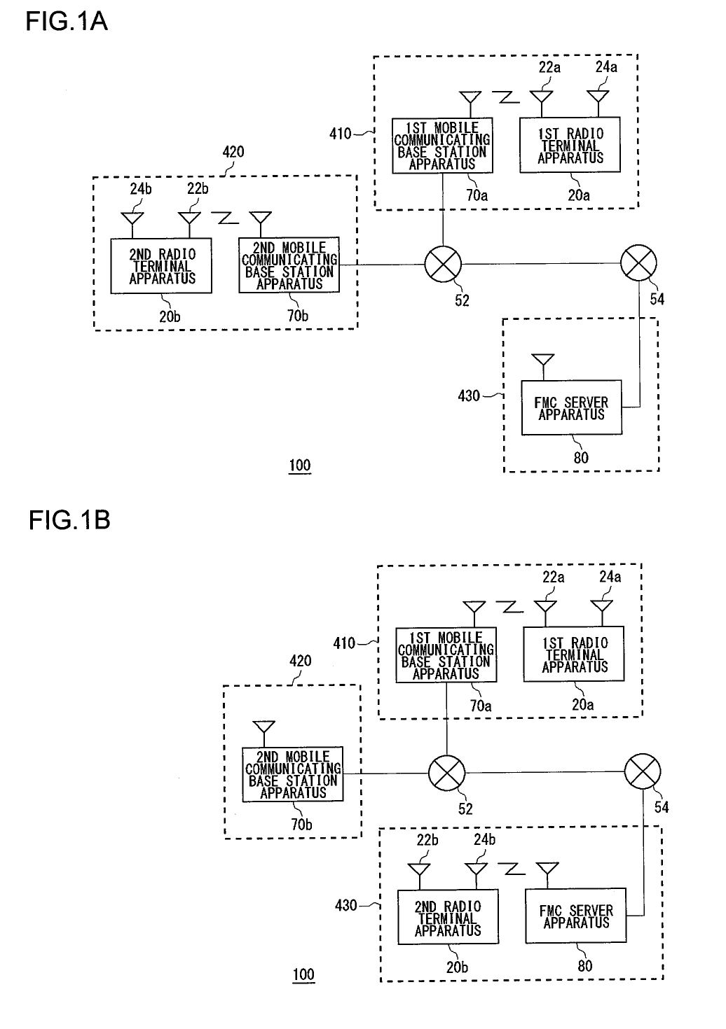

FIGS. 1A and 1B are diagrams showing an FMC communication system 100 according to a first exemplary embodiment and a second exemplary embodiment of the present invention. In FIGS. 1A and 1B, the FMC communication system 100 includes: an FMC server 80; a mobile communication network 52 and a fixed communication network 54 which are represented by a network 5; a first radio terminal apparatus 20a and a second radio terminal apparatus 20b which are represented by a radio terminal apparatus 20; and a first mobile communicating base station apparatus 70a and a second mobile communicating base station apparatus 70b which are represented by a mobile communicating base station apparatus 70. The first radio terminal apparatus 20a and the second radio terminal apparatus 20b include a first mobile radio antenna 22a or a second mobile radio antenna 22b for performing mobile communications with the mobile communicating base station apparatus 70, and a first wireless LAN antenna 24a or a second wireless LAN antenna 24b for performing wireless LAN communication with a display control apparatus 10. Hereinbelow, a mobile radio antenna 22 represents the first mobile radio antenna 22a and the second mobile radio antenna 22b, and a wireless LAN antenna 24 represents the first wireless LAN antenna 24a and the second LAN antenna 24b. Note that the FMC communication system 100 may include a not-shown control server provided between the mobile communication network 52 and the fixed communication network 54.

The mobile communicating base station apparatus 70 and the FMC server 80 perform wireless communications with radio terminal apparatuses 20 existing in their respective communication areas. In FIG. 1A, the first mobile communicating base station apparatus 70a executes wireless communication with the first radio terminal apparatus 20a existing in a first communication area 410 indicated by dotted lines. And the second mobile communicating base station apparatus 70b executes wireless communication with the second wireless radio terminal apparatus 20b existing in a second communication area 420 indicated by dotted lines. Note that the first communication area 410 and the second communication area 420 may be outdoor communication areas. The first communication area 410 and the second communication area 420 are communication areas having a range larger than that of a third communication area 430 described later.

For example, when communication is executed between the first radio terminal apparatus 20a and the second radio terminal apparatus 20b, the first radio terminal apparatus 20a first executes wireless communication with the first mobile communicating base station apparatus 70a. Then the first mobile communication base station apparatus 70a executes wired communication with the second mobile communication base station apparatus 70b via the network 50. Further, the second mobile communication base station apparatus 70b executes wireless communication with the second radio terminal apparatus 20b, thereby enabling communication between the first radio terminal apparatus 20a and the second radio terminal apparatus 20b. The wireless communication between the radio terminal apparatus 20 and the mobile communicating base station apparatus 70 as shown in FIG. 1A may be executed using a known mobile communication scheme such as a CDMA communication scheme.

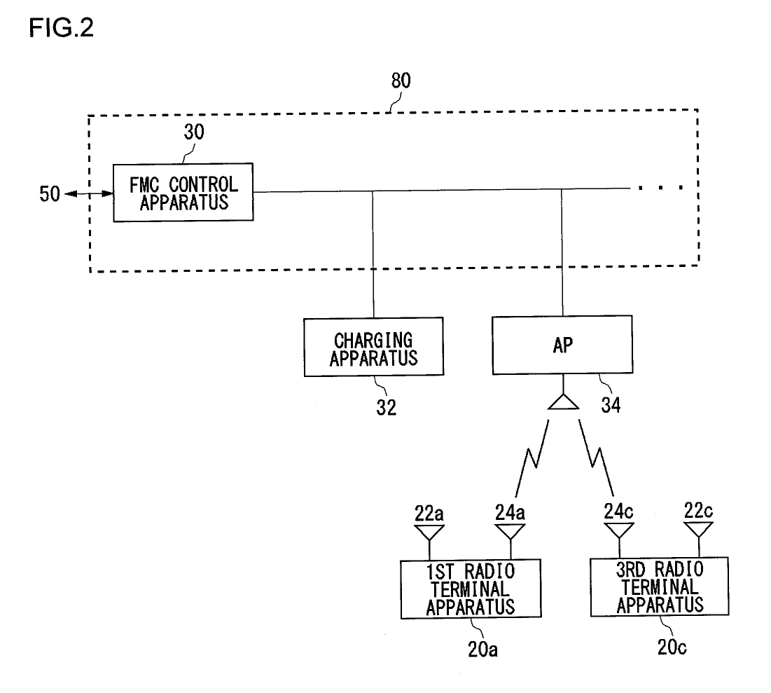

FIG. 2B shows a case where the second radio terminal apparatus 20b existing in the second communication area 42 in FIG. 1A moves into the third communication area 430. In FIG. 1B, when communication is to be executed between the first radio terminal apparatus 20a and the second radio terminal apparatus 20b, the first radio terminal apparatus 20a first executes wireless communication with the first mobile communicating base station apparatus 70a. Then the first mobile communicating base station apparatus 70a executes wired communication with the FMC server 80 via the mobile communication network 52 and the fixed communication network 54.

Here, the FMC server 80 executes communication with the second radio terminal apparatus 20b by using a wireless communication scheme different from that used in between the radio terminal apparatus 20 and the mobile communicating base station apparatus 70, thereby enabling communication between the first radio communication apparatus 20a and the second radio terminal apparatus 20b. Note that a “communication scheme different from that” includes a communication scheme such as a wireless LAN scheme and it may be a short-distance wireless communication scheme where the communication area thereof is narrower than the mobile communication. A description is given here of communication using a wireless LAN scheme. In this case, the FMC server 80 recognizes the second radio terminal apparatus 20b as a terminal apparatus using a short-range wireless communication scheme such as a wireless LAN scheme. Hence, the signals transmitted via the network 50 can be relayed to the second radio terminal apparatus 20b.

A relay processing is executed by the following procedure. Firstly, when the second radio terminal apparatus 20b moves into the third communication area 430 of the FMC server 80, the second radio terminal apparatus 20b transmits identification information to the FMC server 80 and then the FMC server 80 recognizes the identification information and registers it. Then the FMC server 80 registers the identification information on the second radio terminal apparatus 20b in a not-shown control server. Here, if a request of a communication is made to the second radio terminal apparatus 20b, a control server will set the channel of the communication to a channel through the FMC server 80. By performing such a processing, the second radio terminal apparatus 20b can execute communications by a wireless LAN scheme via the FMC server 80. Note that the second radio terminal apparatus 20b, instead of the FMC server 80, may register the identification information in the control server.

Generally, communication environments in short-distance radio communication schemes are stable, in most cases, as compared with a normal mobile communication scheme. Hence, the communication quality is excellent and the transmission rate and the like are high. Thus, by employing such an embodiment, the radio terminal apparatus 20 can execute communication in any of communication areas and can execute communication in a more desirable communication environment. Also, the radio terminal apparatuses 20 can execute communications by a plurality of radio communication schemes using a single telephone number only, thereby providing flexible communication environments to the user.

FIG. 2 is a diagram showing an exemplary structure of a communication system within the third communication area 430 of FIG. 1. An FMC control apparatus 30, a charging apparatus 32, an access point (hereinafter referred to as “AP 34”), a first radio apparatus 20a and a third radio terminal apparatus 20c are present in the third communication area 430. For convenience of explanation, in what is to follow, a user who owns the first radio terminal apparatus 20a is present in the third communication area 430 and, further, a description will be given of a case where the battery of the first radio terminal apparatus 20a is recharged. Also, a description will be given of a case where identification information and the like such as an IP address in the wireless LAN of the first radio terminal apparatus 20a is registered in the third terminal apparatus 20c. Here, the third radio terminal apparatus 20c does not need to be equipped with the mobile radio antenna 22 and a mobile radio communication unit 26 described later.

The FMC control apparatus 30 performs wireless LAN communication with the radio terminal apparatus 20 via the charging apparatus 32 or the AP 34. The communication between the FMC control apparatus 30 and the charging apparatus 32 and that between the FMC control apparatus 30 and the AP 34 may be executed using a wired or wireless line. The AP 34 relays communication between the FMC control apparatus 30 and the radio terminal apparatus 20. Here, the FMC control apparatus 30 may have a known DHCP function and manage the IP addresses and the like of the first radio terminal apparatus 20a and the third radio terminal apparatus 20c. Though for convenience of explanation a structure shown here is such that the charging apparatus 32 and the AP 34 are each a single unit, a plurality of charging apparatuses 32 and/or a plurality of APs 34 may be connected to the FMC control apparatus 30.

The charging apparatus 32 includes a power supply unit for supplying the radio terminal apparatus 20 with electric power and a not-shown communication unit for relaying communication between the radio terminal apparatus 20 and the FMC control apparatus 30. As soon as a charging terminal of the first radio terminal apparatus 20a comes in contact with a not-shown charging terminal, the charging apparatus 32 supplies the first radio terminal apparatus 20 with electric power. As soon as the charging terminal of the first radio terminal apparatus 20a comes in contact with the charging terminal, the communication unit conveys to the FMC control apparatus 30 to the effect that the first radio terminal apparatus 20a has been detected. This notification may contain the IP address of the first radio terminal apparatus 20a acquired from the first radio terminal apparatus 20a connected. Upon receipt of the notification from the charging apparatus 32, the FMC control apparatus 30 starts relaying communication between the FMC control apparatus 30 and the radio terminal apparatus 20. Thereby, the first radio terminal apparatus 20a can execute communication with the FMC control apparatus 30 not only through the AP 34 but also through the charging apparatus 32.

In the above embodiment, by applying the following procedure, the FMC control apparatus 30 executes a processing of interchanging an independent network communication function, such as wireless LAN, between the first radio terminal apparatus 20a and the third radio terminal apparatus 20c.

(1) The FMC control apparatus 30 detects that the first radio terminal apparatus 20a has been connected with the charging apparatus 32. The FMC control apparatus 30 detects the third radio terminal apparatus 20c through the AP 34.

(2) When the first radio terminal apparatus 20a is connected with the charging apparatus 32, the FMC control apparatus 30 acquires the identification information of the first radio terminal apparatus 20a via the charging apparatus 32. The FMC control apparatus 30 may request the identification information from the first radio terminal apparatus 20a and the third radio terminal apparatus 20c. The FMC control apparatus 30 requests the user data stored in the first radio terminal apparatus 20a. A request signal for the first radio terminal apparatus 20a may be transmitted via the charging apparatus 32 or AP 34.

(3) The FMC control apparatus 30 transmits the identification information received from the first radio terminal apparatus 20a, to the third radio terminal apparatus 20c. The FMC control apparatus 30 transmits the user data received from the first radio terminal apparatus 20a, to the third radio terminal apparatus 20c. Further, the FMC control apparatus 30 may transmit the identification information received from the third radio terminal apparatus 20c, to the first radio terminal apparatus 20a.

(4) The third radio terminal apparatus 20c registers the received identification information as its own identification information. The third radio terminal apparatus 20c registers the received user data. The first radio terminal apparatus 20a may register the received identification information as its own identification information. Here, the user data includes, for example, telephone numbers to call, electronic mail addresses, contents of mails transmitted and received in the past or personal data such as names and addresses associated with those.

Thereby, even if the first radio terminal apparatus 20a is at the middle of the recharging, the user can perform communication, without changing the setting at a network 50 side, by the use of the third radio terminal apparatus 20c having now the telephone numbers of the first radio terminal apparatus 20a. When there is a communication request addressed to a telephone number allocated to the first radio terminal apparatus 20a, its channel is set to the third radio terminal apparatus 20c via the FMC control apparatus 30 and the AP 34.

Next, a description will be given of a procedure in which the first radio terminal apparatus 20a and the third radio terminal apparatus 20c are interchanged again and a return is made to the original usage environment when the user takes out the first radio terminal apparatus 20a from the charging apparatus 32. Note that “when the user takes out the first radio terminal apparatus 20a from the charging apparatus 32” includes not only a case when the power stored in the first radio terminal apparatus 20a becomes the maximum electric energy but also a case when the first radio terminal apparatus 20a during the recharging is detached from the charging apparatus 32.

(1) The FMC control apparatus 30 detects that a radio terminal apparatus 20 is detached from the charging apparatus 32. More specifically, if the fact that the communication with the first radio terminal apparatus 20 cannot be continued via the charging apparatus 32 is detected, the FMC control apparatus 30 decides that the radio terminal apparatus 20 has been detached from the charging apparatus 32. Also, the FMC control apparatus 30 detects the third radio terminal apparatus 20c via the AP 34. Upon receipt of a notification from the first radio terminal apparatus 20a as a result of a user operation that the condition shall be returned to the former use environment, the FMC control apparatus 30 may decide that the radio terminal apparatus 20 has been detached from the charging apparatus 32.

(2) The FMC control apparatus 30 transmits, via the AP 34, identification information request signals to the first radio terminal apparatus 20a and the third radio terminal apparatus 20c, respectively. The FMC control apparatus 30 transmits the identification information received from the third radio terminal apparatus 20c, to the first radio terminal apparatus 20a and has the first radio terminal apparatus 20a register the identification information therein. Further, the FMC control apparatus 30 transmits the identification information received from the first radio terminal apparatus 20a, to the third radio terminal apparatus 20c and has the third radio terminal apparatus 20c register the identification information therein.

(3) Here, the FMC control apparatus 30 transmits to the third radio terminal apparatus 20c a signal by which to request the deletion of the registered user data. Based on the request signal, the third radio terminal apparatus 20c deletes the user data stored.

By employing the above-described embodiment, the use environment can be brought back to the original state. Since the user data do not remain in the third radio terminal apparatus 20c, the security can be enforced. For example, in a case where the FMC control apparatus 30 is installed in a company, the first radio terminal apparatus 20a used by an employee of the company is recharged and the user data are moved to the third radio terminal apparatus 20c used commonly by employees, it is not preferable in terms of security that the user data of the first radio terminal apparatus 20a remain in the third radio terminal apparatus 20. Accordingly, by employing the above-described embodiment, the user data of the first radio terminal apparatus 20a once stored in the third radio terminal apparatus 20c is deleted from the third radio terminal apparatus 20c when the use environments of the first radio terminal apparatus 20a and the third radio terminal apparatus 20c are returned to the original ones. Thereby, the security can be strengthened.

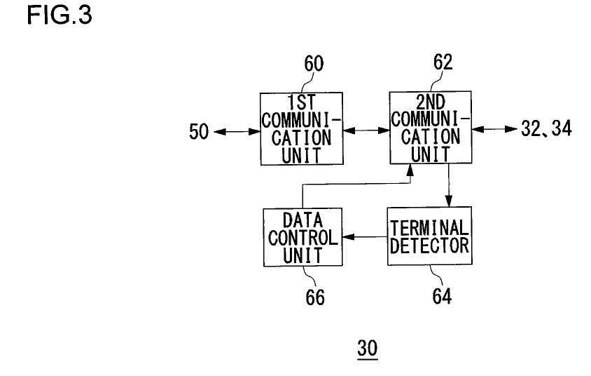

FIG. 3 is a diagram showing an exemplary structure of the FMC control apparatus 30 shown in FIG. 2. The FMC control apparatus 30 includes a first communication unit 60, a second communication unit 62, a terminal detector 64, and a data control unit 66. The second communication unit 62 performs wireless LAN communication with the radio terminal apparatuses 20 via the AP 34. The second communication unit 62 performs wired communication with the charging apparatus 32, and performs wired communication with the radio terminal apparatuses 20 via the charging apparatus 32. In these communications, the second communication unit 62 relays the communication with the network 50, via the first communication unit 60. Similarly, the first communication unit 60 relays the received signals by way of the network 50, and relays the signals transmitted from the second communication unit 62, to the network 50.

Here, if it is notified that the radio terminal apparatus 20 has been connected/detached to/from the charging apparatus 32 or if it is notified via the AP 34 that the radio terminal apparatus 20 has been detected, the second communication unit 62 will convey the notification to the terminal detector 64. The identification information by which to identify the detected radio terminal apparatus 20 or user data stored in the radio terminal apparatus 20 may be contained in the notification. If the first radio terminal apparatus 20a is detected via the charging apparatus 32 and the third radio terminal apparatus 20c is detected via the AP 34, the terminal detector 64 will inform the data control unit 66 of the respective identification numbers of the first radio terminal apparatus 20a and the third radio terminal apparatus 20c. If it is notified that the first radio terminal apparatus 20a has been detached from the charging apparatus 32, the terminal detector 64 will inform the data control unit 66 accordingly.

If both the first radio terminal apparatus 20a and the third radio terminal apparatus 20c are detected by the terminal detector 64, the data control unit 66 will have the third radio terminal apparatus 20c store the user data therein by interchanging the identification information of the first radio terminal apparatus 20a and that of the third radio terminal apparatus 20c. More specifically, the data control unit 66 has the second communication unit 62 transmit a request signal to the first radio terminal apparatus 20a wherein the request signal indicates that the identification information of the third radio terminal apparatus 20c is to be registered as its own identification information. The data control unit 66 has the second communication unit 62 transmit a request signal to the third radio terminal apparatus 20c wherein the request signal indicates that the identification information of the first radio terminal apparatus 20a is to be registered as its own identification information. At the same time, the data control unit 66 has the second communication unit 62 transmit a request signal indicating that the user data stored in the first radio terminal apparatus 20a is to be stored. Thereby, the first radio terminal apparatus 20a and the third radio terminal apparatus 20c can be interchanged.

If the original state is restored by interchanging the first radio terminal apparatus 20a and the third radio terminal apparatus 20c after having interchanged the first radio terminal apparatus 20a and the third radio terminal apparatus 20c, the data control unit 66 will delete the predetermined data stored in the third radio terminal apparatus 20c. More specifically, if notified via the terminal detector 64 that the first radio terminal apparatus 20a has been detached from the charging apparatus 32 after having interchanged the first radio terminal apparatus 20a and the third radio terminal apparatus 20c, the data control unit 66 will have the second communication unit 62 transmit to the third radio terminal apparatus 20c a request signal indicating that the identification registered in the first radio terminal apparatus 20a be registered therein and at the same time the user data stored in the third radio terminal apparatus 20c be deleted. Also, it has the second communication unit 62 transmit to the first radio terminal apparatus 20a a request signal indicating that the identification information registered in the third radio terminal 20c be registered therein. By employing the embodiment like this, the original state can be restored.

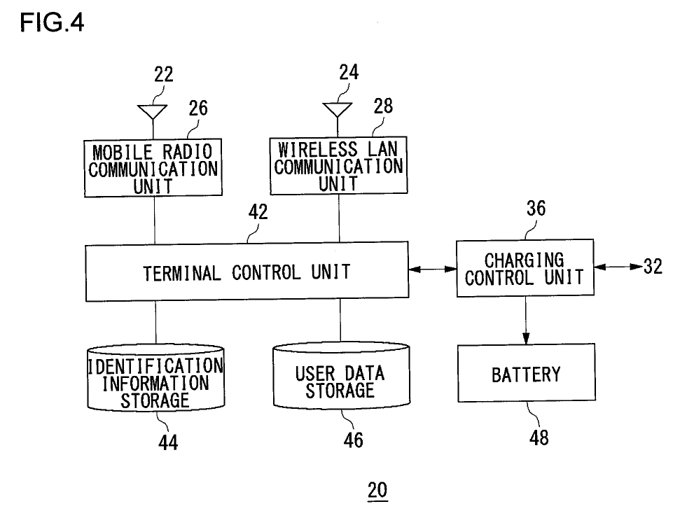

FIG. 4 is a diagram showing an exemplary structure of the first radio terminal apparatus 20a or the third radio terminal apparatus 20c shown in FIG. 2. Here, for convenience of explanation, a description will be given assuming that the first radio terminal apparatus 20a or the third radio terminal apparatus 20c is the radio terminal apparatus 20. The radio terminal apparatus 20 includes a mobile radio antenna 22, a wireless LAN antenna 24, a mobile radio communication unit 26, a wireless LAN communication unit 28, a terminal control unit 42, an identification information storage 44, a user data storage 46, a charging control unit 36, and a battery 48.

The mobile radio antenna 22, which is connected with the mobile radio communication unit 26, conducts a processing of transmitting and receiving signals using a mobile radio scheme. The mobile radio communication unit 26 performs a modem processing, such as error correction processing, on the signals transmitted from the mobile radio antenna 22 or terminal control unit 42. The mobile radio antenna 22 is used to execute mobile radio communication with the first radio communication base station apparatus 70a or second mobile communicating base station apparatus 70b in the first communication area 410 or second communication area 420 shown in FIG. 1.

The wireless LAN antenna 24, which is connected with the wireless LAN communication unit 28, conducts a processing of transmitting and receiving signals using a wireless LAN scheme. The wireless LAN communication unit 28 performs a modem processing, such as error correction processing, on the signals transmitted from the wireless LAN antenna 24 or terminal control unit 42. The wireless LAN antenna 24 is used to execute wireless LAN communication with the FMC server 80 in the third communication area 430 shown in FIG. 1.

The charging control unit 36 relays the power supplied from the charging apparatus 32, to the battery 48. The battery 48 stores up the power thus supplied. When the charging control unit 36 receives a communication signal from the FMC control apparatus 30 via the charging apparatus 32, it relays the signal to the terminal control unit 42. As a result, the radio terminal apparatus 20 can perform wireless communication with the FMC control apparatus 30.

The terminal control unit 42 manages the exchanging of the execution of communication in the mobile radio communication 26 and the wireless LAN communication unit 28, according to the communication area shown in FIG. 1. According to instructions sent from a not-shown FMC control apparatus 30 via the wireless LAN communication unit 28 in the third communication area 430, the terminal control unit 42 accesses the identification storage 44 or the user data storage 46 so as to perform registration or deletion processing thereon.

The identification information storage 44 stores the identification storage according to instructions from the terminal control unit 42. The user data storage 46 stores the user data according to the instructions from the terminal control unit 42. When the third radio terminal apparatus 20c is used, the user data stored in the user data storage 46 are deleted according to the instructions sent from the terminal control unit 42.

These structures as described above may be implemented hardwarewise by elements such as a CPU, memory and other LSIs of an arbitrary computer, and softwarewise by memory-loaded programs or the like. Depicted herein are functional blocks implemented by cooperation of these. Therefore, it is understood by those skilled in the art that the functional blocks may be implemented by a variety of manners including hardware only, software only or a combination of both.

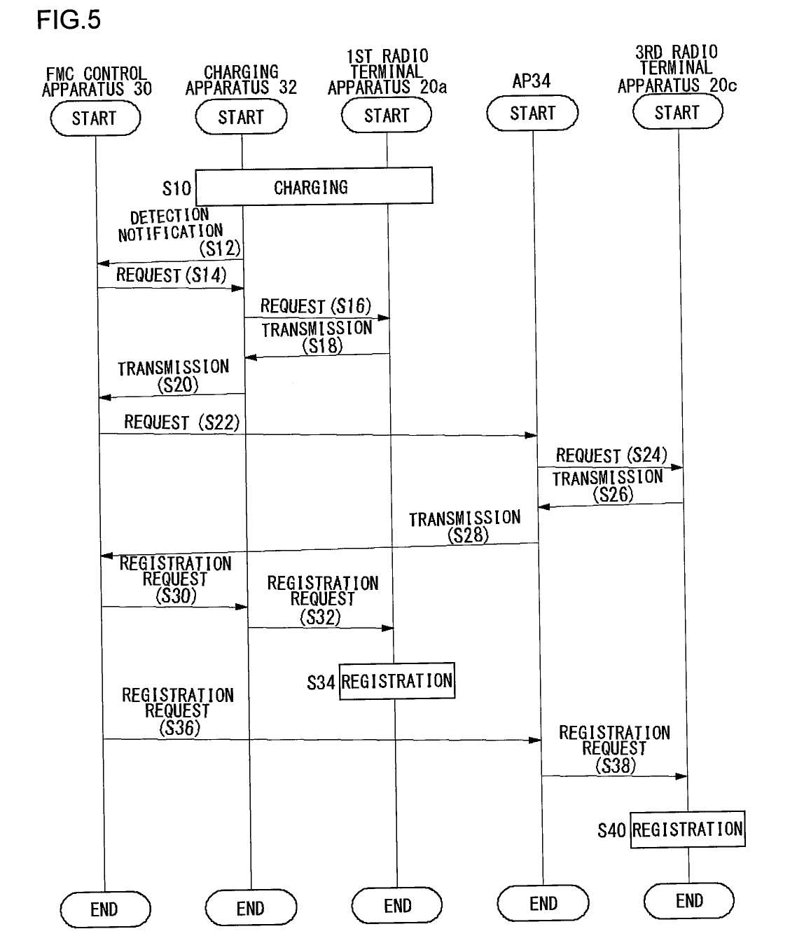

Next, an operation of the FMC control apparatus 30 will be described. FIG. 5 is a sequence diagram showing an operational example of a communication system in the third communication area 430 shown in FIG. 1. This processing may be started as soon as the user connects the first radio terminal apparatus 20a with the charging apparatus 32. Or it may be started upon receipt of a start request from the user.

Firstly, the charging apparatus 32 detects that the charging of the first radio terminal apparatus 20a is started (S10), which is notified to the FMC control apparatus 30 (S12). Here, the FMC control apparatus 30 transmits a signal requesting the transmission of the identification information and the user data to the first radio terminal apparatus 20a via the charging apparatus 32 (S14, S16) Here, the first radio terminal apparatus 20a, to which the transmission thereof has been requested, transmits the identification information stored in the identification information storage 44 and the user data stored in the user data storage 46 shown in FIG. 4, to the FMC control apparatus 30 via the charging apparatus 32 (S18, S20).

Also, the FMC control apparatus 30 transmits a signal requesting the transmission of the identification information to the third radio terminal apparatus 20c via the AP 34 (S22, S24). Here, the third radio terminal apparatus 20c, to which the transmission thereof has been requested, transmits the identification information stored in the identification information storage 44 shown in FIG. 4, to the FMC control apparatus 30 via the AP 34 (S26, S28).

Further, the FMC control apparatus 30 requests the first radio terminal apparatus 20a to register the identification information transmitted from the third radio terminal apparatus 20c as its own identification information, via the charging apparatus 32 (S30, S32). Upon receipt of such a request, the first radio terminal apparatus 20a registers the transmitted identification information in the identification information storage 44 as its own identification information (S34).

Also, the FMC control apparatus 30 requests the third radio terminal apparatus 20c to register the identification information and user data transmitted from the first radio terminal apparatus 20a as its own identification information, via the AP 34 (S36, S38). Upon receipt of such a request, the third radio terminal apparatus 20c registers the transmitted identification information in the identification information storage 44 as its own identification information, and registers the transmitted user data in the user data storage 46 (S40).

By employing the above embodiment, predetermined data are stored in another wireless communication apparatus by interchanging the identification information of the radio terminal apparatus 20 whose battery is being recharged and that of another radio terminal apparatus 20, so that the identical telephone numbers can be switched among a plurality of radio terminal apparatuses 20. Thereby, even though the battery of a terminal apparatus 20 is being recharged, radio terminal apparatuses 20 having the same function can be used, so that user convenience can be improved. In a case when the identification information of the radio terminal apparatus 20 whose battery is being recharged and the identification information of another radio terminal apparatus 20 are interchanged therebetween and then the identification information of the radio terminal apparatus 20 being recharged and the identification information of the another radio terminal apparatus 20 are interchanged again, the predetermined data stored in the another radio terminal apparatus 20 is deleted. Thus, the management of information security can be enforced.

A description is next given of a modification to the embodiment of the present invention. Parts common to the above-described embodiment are given the same reference numerals and the explanation thereof will be simplified. The present modification relates to an FMC communication system 200. The FMC communication system 200 has the same structure as that shown in FIG. 2, and includes an FMC control apparatus 30, a radio terminal apparatus 20, a charging apparatus 32 and an AP 34. Similar to the one described above, among a plurality of radio terminal apparatuses, the FMC control apparatus 30 interchanges the telephone number and so forth allocated to a radio communication terminal whose battery is being recharged and those allocated to other radio communication terminals. Further, the FMC control apparatus 30 sets a mobile communication function disabled for a radio communication terminal whose battery is being recharged, and sets the mobile communication functions enabled for the other radio terminal apparatuses.

Thereby, even if the battery of a predetermined radio communication terminal is being recharged, the user can use telephone number allocated to the mobile terminal apparatus whose battery is being recharged and perform the mobile communication, such as normal telephone calls, by operating on another radio communication terminal in the same circumstances as those of the radio terminal apparatus whose battery is being recharged. And if the user who goes out carries another radio communication terminal instead of the radio terminal apparatus whose battery is being recharged, the user can perform communication even outside the range of the third communication area 430 of the FMC communication system 200.

The FMC communication system 200 has the same structure as that shown in FIG. 2, and includes an FMC control apparatus 30, a first radio terminal apparatus 20a, a third radio terminal apparatus 20c, a charging apparatus 32 and an AP 34. The FMC control apparatus 30 has the same structure as that shown in FIG. 3. The first radio terminal apparatus 20a and the third radio terminal apparatus 20c each has the same structure as that shown in FIG. 4. In such a case, however, it is assumed that the first radio terminal apparatus 20a sets both the function of the mobile radio communication 26 and the function of the wireless LAN communication unit 28 enabled whereas the third radio terminal apparatus 20c sets the function of the wireless LAN communication unit 28 enabled. On the other hand, it is assumed that the mobile radio communication unit 26 in the third radio terminal apparatus 20c is set disabled.

As soon as the charging terminal of the first radio terminal apparatus 20a comes in contact with the charging terminal, the charging apparatus 32 conveys a notification to the FMC control apparatus 30 indicating that the first radio terminal apparatus 20a has been detected. Upon receipt of the notification from the charging apparatus 32, the FMC control apparatus 30 starts a communication relay between the FMC control apparatus 30 and the radio terminal apparatus 20. As a result, the radio terminal apparatus 20 can communicate with the FMC control apparatus 30 by way of not only the AP 34 but also the charging apparatus 32.

The terminal detector 64 detects the first radio terminal apparatus 20a connected with the charging apparatus 32. Here, the first radio terminal apparatus 20, which is connected with the charging apparatus 32, stores predetermined user data, has a radio communication function containing at least a radio communication function for public usage, and is a radio terminal apparatus 20 in which the radio communication function for public usage is set enabled. The terminal detector 64 has a radio communication function for public usage and an independent network radio communication function, and detects via the AP 34 the third radio terminal apparatus 20c where the radio communication function for public usage is set enabled.

When the first radio terminal apparatus 20a and the third radio terminal apparatus 20c are both detected by the terminal detector 64, the data control unit 66 sets disabled the radio communication function for public usage in the first radio terminal apparatus 20a and sets enabled the radio communication function for public usage in the third radio terminal apparatus 20c so as to have the second radio communication apparatus store the predetermined user data.

When returning the radio communication function for public usage in the first radio terminal apparatus 20a to an enabled state after having set disabled the radio communication function for public usage in the first radio terminal apparatus 20a, the data control unit 66 has the third radio terminal apparatus 20c transmit a signal to the second communication unit indicating that the predetermined user data be deleted from the third radio terminal apparatus while setting disabled the radio communication function for public usage in the third radio terminal apparatus 20c.

By employing the above embodiment, according to the following procedure, the FMC control apparatus 30 controls the setting/deactivation of function validity related to the mobile communication of the first radio terminal apparatus 20a and the third radio terminal apparatus 20c. As for the processing of interchanging identification information or user data, the same processing as that described above is preferably executed. Thus, the interchanging processing will be described in a simplified manner.

(1) The FMC control apparatus 30 detects that the first radio terminal apparatus 20a has been connected with the charging apparatus 32. The FMC control apparatus 30 detects the third radio terminal apparatus 20c via the AP 34. The FMC control apparatus 30 may detect the third radio terminal apparatus 20c via the first radio terminal apparatus 20a connected with the charging apparatus 32.

(2) The FMC control apparatus 30 performs a processing of interchanging their respective identification information of the first radio terminal apparatus 20a and the third radio terminal apparatus 20c. The FMC control apparatus 30 has the user data of the first radio terminal apparatus 20a registered in the user data storage 46 of the third radio terminal apparatus 20c.

(3) The FMC control apparatus 30 acquires information by which to enable the mobile communication (hereinafter this information will be referred to as “setting information”) from the first radio terminal apparatus 20a. The setting information contains the identification information allocated from a telecommunications carrier. The FMC control apparatus 30 requests the first radio terminal apparatus 20a that the function related to the mobile radio communication unit 26 of the first radio terminal apparatus 20a should be set disabled. The first radio terminal apparatus 20a deletes the setting information registered and sets the function related to the mobile radio communication unit 26 disabled.

(4) Further, the FMC control apparatus 30 sets the function related to the mobile radio communication unit 26 in the third radio terminal apparatus 20c enabled, via the AP 34. More specifically, the FMC control apparatus 30 transmits to the third radio terminal apparatus 20c a setting request signal that contains the setting information. The third radio terminal apparatus 20c receives the setting request signal by the wireless LAN communication unit 28. The setting request signal is conveyed to the terminal control unit 42, and the setting information contained in the setting request signal is registered. And the function related to the mobile radio communication unit 26 is set enabled.

Next, a description will be given of a procedure in which the first radio terminal apparatus 20a and the third radio terminal apparatus 20c are interchanged again and a return is made to the original usage environment when the user removes the first radio terminal apparatus 20a from the charging apparatus 32.

(1) The FMC control apparatus 30 first detects that the radio terminal apparatus 20a is detached from the charging apparatus 32. Also, the FMC control apparatus 30 detects the third radio terminal apparatus 20c via the AP 34. If the third radio terminal apparatus 20c cannot be detected, it will be decided that the third radio terminal apparatus 20c as well as the user lies outside the range of the third communication area 430. As a result, the following processing will not be executed.

(2) If the FMC control apparatus 30 detects both the first radio terminal apparatus 20a and the third radio terminal apparatus 20c, the FMC control apparatus 30 will first acquire the setting information from the third radio terminal apparatus 20c. Also, the FMC control apparatus 30 requests of the third radio terminal apparatus 20c that the function related to the mobile communication be set disabled and the setting information be deleted. Then the FMC control apparatus 30 transmits the setting information acquired from the third radio terminal apparatus 20c, to the first radio terminal apparatus 20a and has it registered so as to set enabled the function related to the mobile communication of the first radio terminal apparatus 20.

(3) Here, the FMC control apparatus 30 transmits to the third radio terminal apparatus 20c a signal by which to request the deletion of the registered user data. Based on the request signal, the third radio terminal apparatus 20c deletes the user data stored.

By employing the above-described embodiment, only a single unit of the radio terminal apparatus 20 can be used simultaneously, so that the security can be strengthened. Prior to the setting/deactivation of validity of mobile communication functions, a password is acquired from the first radio terminal apparatus 20a. And if it agrees with the password set beforehand in the FMC control apparatus 30, the FMC control apparatus 30 may perform the processing for the setting/deactivation of the validity of mobile communication functions. As a result, the security can be further enforced.

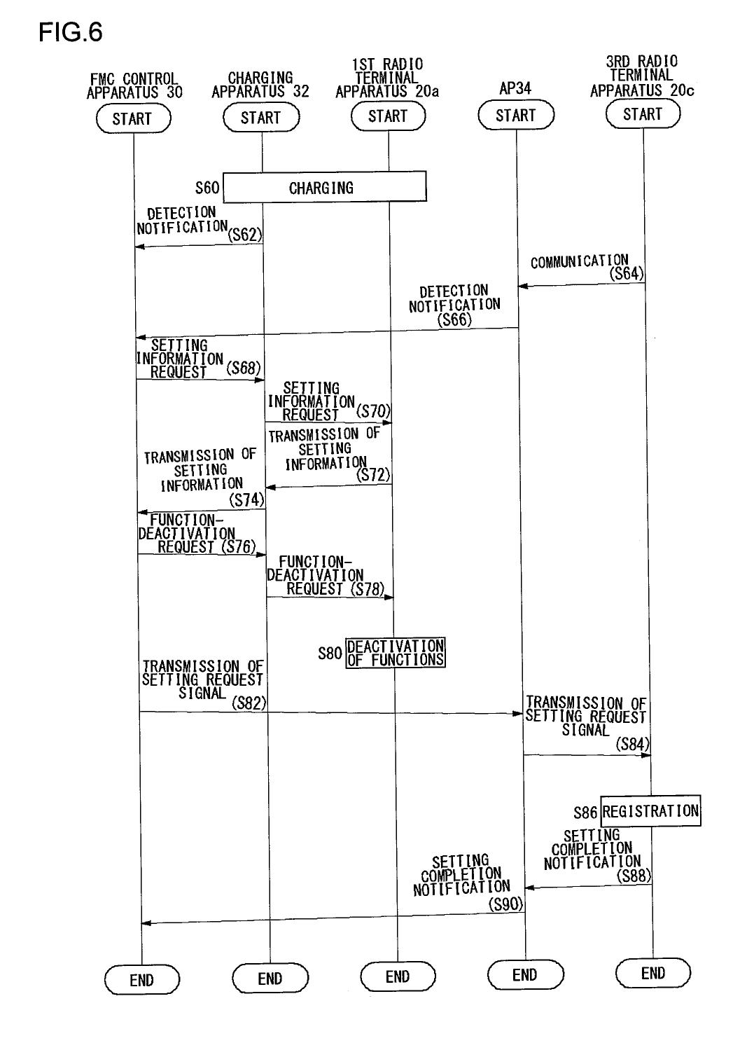

FIG. 6 is a sequence diagram showing an operational example of a communication system according to a modification of the embodiment of the present invention. This processing may be started as soon as the user connects the first radio terminal apparatus 20a with the charging apparatus 32 or upon receipt of a start request from the user.

Firstly, the charging apparatus 32 detects that the charging of the first radio terminal apparatus 20a is started (S60), which is notified to the FMC control apparatus 30 (S62). If a request of communication is made from the third radio terminal apparatus 20c (S64), the AP 34 will convey to the FMC control apparatus 30 that the start of the charging has been detected (S66). The FMC control apparatus 30 transmits a signal requesting the transmission of the setting information to the first radio terminal apparatus 20a via the charging apparatus 32 (S68, S70). Here, the first radio terminal apparatus 20a, to which the transmission thereof has been requested, transmits the setting information to the FMC control apparatus 30 via the charging apparatus 32 (S72, S74).

Then the FMC control apparatus 30 requests the first radio terminal apparatus 20a to terminate the functions of the mobile radio communication unit 26 shown in FIG. 4 via the charging apparatus 32 (S76, S78). The first radio terminal apparatus 20a terminates the functions of the mobile radio communication unit 26 by deleting the setting information registered and sets these functions disabled (S80).

Further, the FMC control apparatus 30 transmits the setting request signal to the third radio terminal apparatus 20c via the AP 34 (S82, S84). The third radio terminal apparatus 20c registers the setting information contained in the transmitted setting request signal as its own setting information, thereby setting the functions of the mobile radio communication unit 26 enabled (S86). When the setting has been completed, the third radio terminal apparatus 20c conveys to the FMC control apparatus 30 via the AP 34 that the setting has been completed (S88, S90).

By employing the above embodiment, in this modification the predetermined data is stored in the another radio terminal apparatus 20 in a manner that the mobile communication functions in the radio terminal apparatus 20 whose battery is being recharged are set disabled and the mobile communication functions in another radio terminal apparatus 20 are set enabled. As a result, only any one of radio terminal apparatuses 20 is capable of performing communication and therefore the management of information security can be enforced. Although the battery of a predetermined radio terminal 20 is being recharged, the user can perform the communication such as normal telephone calls in the same environments as those of the radio terminal apparatus 20 whose battery is being recharged by operating on another radio terminal apparatus using the telephone number allocated to the radio terminal apparatus whose battery is being recharged. If the user who goes out carries another radio communication terminal instead of the radio terminal apparatus whose battery is being recharged, the user can perform communication even outside the range of the third communication area 430 of the FMC communication system 200.

The present invention has been described based on the embodiments. These embodiments are merely exemplary, and it is understood by those skilled in the art that various modifications to the combination of each constituting element and each process thereof are possible and that such modifications are also within the scope of the present invention.

A description has been given in the above exemplary embodiment where the FMC control apparatus 30 detects the third radio terminal apparatus 20c via the AP 34. However, the FMC control apparatus 30 may detect the third radio terminal apparatus 20c by way of the first radio terminal apparatus 20a connected with the charging apparatus 32. In this case, it is preferable that the first radio terminal apparatus 20a and the third radio terminal apparatus 20c each be provided with a not-shown short-distance wireless communication unit. It goes without saying that such an embodiment as this can obtain the same effect as that described above.

A description has been given in the above exemplary embodiment where the FMC control apparatus 30 interchanges the identification information of the first radio terminal apparatus 20a and the third radio terminal apparatus 20c. However, the exemplary embodiments are not limited thereto, and the FMC control apparatus 30 may not have the identification information of the third radio terminal apparatus 20c stored by the first radio terminal apparatus 20a. Also, the first radio terminal apparatus 20a may stop the functions of the wireless LAN communication unit 28. In such a case, the first radio terminal apparatus 20a can perform communications via the AP 34 only.

According to the present invention, a terminal exchanging method for controlling a plurality of terminal apparatuses and a terminal exchanging apparatus using the method can be achieved.

While the preferred embodiments of the present invention have been described using specific terms, such description including objectives and applications is for illustrative purposes only, and it is to be understood that other changes and variations may be made without departing from the spirit or scope of the appended claims.

What is claimed is:

1. A terminal exchanging apparatus, comprising:
a terminal detector which detects a first radio terminal apparatus and a second radio terminal apparatus, respectively, wherein a first identification information for identifying a radio terminal apparatus and predetermined data are stored in the first radio terminal apparatus and a second identification information differing from the first identification information is stored in the second radio terminal apparatus; and
a data control unit which makes the predetermined data stored in the second radio communication apparatus while making the first identification information stored in the second radio terminal apparatus, when both the first radio terminal apparatus and the second radio terminal apparatus are detected by the terminal detector.

2. A terminal exchanging apparatus according to claim 1, wherein the first radio terminal apparatus and the second radio terminal apparatus each performs a radio communication which differs from that associated with the identification information thereof, and
wherein the terminal detector detects the second terminal apparatus via the first radio terminal apparatus by performing the different radio communication.

3. A terminal exchanging apparatus according to claim 1, wherein when the identification information of the second radio terminal apparatus is restored to an original state after the identification information of the first radio terminal apparatus has been stored in the second radio terminal apparatus, the data control unit deletes the predetermined data stored in the second radio terminal apparatus.

4. A terminal exchanging apparatus according to claim 1, wherein when the terminal detector detects that the first radio terminal apparatus is being recharged, the data control unit causes the second radio terminal apparatus to store the predetermined data.

5. A terminal exchanging apparatus according to claim 3, wherein when the terminal detector detects that the first radio terminal apparatus is no longer recharged, the data control unit deletes the predetermined data stored in the second radio terminal apparatus.

6. A terminal exchanging apparatus, comprising:
a terminal detector which detects a first radio terminal apparatus and detects a second radio terminal apparatus via an independent network wherein the first radio terminal stores predetermined data and a radio communication function for public usage is set enabled in the first radio terminal and wherein the second radio terminal apparatus has the radio communication function for public usage and an independent network radio communication function and the radio communication function for public usage is set disabled in the second radio terminal apparatus; and
a data control unit which causes the second radio terminal apparatus to store the predetermined data in a manner that the radio communication function for public usage in the first radio terminal apparatus is set disabled and the radio communication function for public usage in the second radio terminal apparatus is set enabled, when both the first radio terminal apparatus and the second radio terminal apparatus are detected by the terminal detector.

7. A terminal exchanging apparatus according to claim 6, wherein when the radio communication function for public usage in the first radio terminal apparatus is restored to an enabled state after the radio communication function for public usage in the first radio terminal apparatus has been set disabled, the data control unit deletes the predetermined data by setting disabled the radio communication function for public usage in the second radio terminal apparatus.

8. A terminal exchanging method wherein when a first radio terminal apparatus in which identification information for identifying a radio terminal apparatus and predetermined data are stored and a second radio terminal apparatus in which identification information differing from the identification information is stored are detected, the predetermined data are stored in the second radio communication apparatus by storing the identification of the first radio terminal apparatus in the second radio terminal apparatus.

9. A terminal exchanging method wherein when a first radio terminal apparatus, having at least a radio communication function for public usage, in which the radio communication function for public usage is set enabled is detected and a second radio terminal apparatus, having the radio communication function for public usage and an independent network radio communication function, in which the radio communication function for public usage is set disabled is detected via an independent network, the predetermined data are stored in the second radio communication in a manner that the radio communication function for public usage in the first radio terminal apparatus is set disabled and the radio communication function for public usage in the second radio terminal apparatus is set enabled.
